(19) United States
(12) Patent Application Publication
(10) Pub. No.: US 2026/0347639 A1
(43) Pub. Date: Nov. 5, 2026

(54) RAW MATERIAL SUBSTITUTE AND MANUFACTURING PROCESS FOR ASPHALT COAT SEAL PRODUCTS

(71) Applicant: Brian Lee BRITTAIN, Covina, CA (US)

(72) Inventor: Brian Lee BRITTAIN, Covina, CA (US)

(21) Appl. No.: 19/662,745

(22) Filed: Apr. 29, 2026

Related U.S. Application Data
(60) Provisional application No. 63/797,310, filed on Apr. 30, 2025.

(51) Int. Cl. C09D 133/08; C08K 3/04; C08K 3/26; C08K 3/34; C08K 3/36; C08L 33/08

(52) U.S. Cl. CPC C09D 133/08; C08K 3/04; C08K 3/26; C08K 3/346; C08K 3/36; C08L 33/08; C08K 2003/265

(57) ABSTRACT

The disclosure relates generally to raw material substitute and manufacturing process for asphalt coat seal products. The asphalt coat seal products may be a blend from waste products. For example, the seal coat additive includes waste products in a blend comprising water and materials selected from vinyl acrylic latex, carbon black, fuller's earth, silica limestone, cellulose and quartz.

### BACKGROUND

### FIELD OF THE INVENTION

The invention relates generally to raw material substitute and manufacturing process for ingredients of asphalt coat seal products.

### BACKGROUND

Currently, numerous asphalt seal coat products populate the marketplace due to the high demand of this product in today's continually developing global culture of infrastructure creation and maintenance, including paved roads, runways, and parking lots. Due to this high demand and the massive volumes of this type of product, the quality of asphalt seal coat products is often lacking. Unfortunately the cheapest products are frequently sourced in large volumes. Additionally, these products are comprised of various raw materials that have been excavated from the earth, purchased separately, mixed, and manufactured to create the final asphalt seal coat product. This process is problematic from the beginning, as current asphalt seal coat products lack quality, are damaging to the environment, expensive, as well as time and labor-intensive, creating unnecessary financial and operational burdens on manufacturers throughout the manufacturing process.

### SUMMARY OF THE INVENTION

The asphalt seal coat substitute (e.g., additive) of the present invention is derived of various post-consumer waste products, eliminating the need to include several virgin raw materials contained in traditional asphalt seal coat products, thus protecting the environment. It is also inexpensive, and reduces labor costs by cutting out aspects of the manufacturing process associated with obtaining, measuring, and adding several different raw materials to the asphalt seal coat. By eliminating these steps, our product also improves efficiencies throughout the manufacturing process. Lastly, the asphalt seal coat additive contains a high percentage of necessary ingredients with minimal dilution, ensuring a high-quality, low-cost product. Manufacturers have the opportunity to customize the percentages of the asphalt seal coat additive formula according to their product requirements.

It is desirable to have a process for asphalt seal coat manufacturing which utilizes fewer virgin raw materials and replaces them with post-consumer waste products, thus helping to keep millions of pounds of waste out of landfills and/or incineration, preserving the environment. Furthermore, it is desirable to have a process that lowers operational costs. Still further, it is desirable to have a process that provides the opportunity for enhancing the quality of the final product and which may be used for all or most all asphalt seal products. According to 5 years of laboratory and real world testing, the disclosed process advantageously fills these needs and addresses the aforementioned deficiencies by providing a process that replaces virgin raw materials with post-consumer waste products, lowers operational costs, can enhance the quality of the final product, and preserves the environment by keeping waste out of landfills and/or incineration. The results of our years of testing proved this process and method lowers costs, environmental impact, and enhances quality.

Disclosed is a description of our asphalt seal coat (e.g., resin) additive, which replaces a percentage of virgin ingredients of traditional asphalt seal coat products with our post-consumer/manufacturer formula. For example, the formula may contain a blend of the following ingredients from multiple non-hazardous industrial waste streams including any combination with water of: 10-20% vinyl acrylic latex, 0-15% and, in embodiments, greater than or equal to 2% carbon black (or in some embodiments, less than 2% depending on the desired formulation and product in which it will be added), < 5% fuller's earth, < 60% silica (amorphous), < 10% limestone, < 5% cellulose, < 20% quartz (SiO₂), and < 50% water. These percentages can be variable for each product/application. The percentages noted herein have been found to be consistent from years of testing and proving this method and process.

The asphalt seal coat additive formula may be customized according to the purchaser's raw materials requirements. For example, the formula may or may not contain aggregates, carbon black, biocides, preservatives, PH adjustment, etc. These aspects of the formula can be customized based on the customer's demands and the constituent parts of the base seal coat. This may impact the viscosity, percent solids, weight per gallon, VOC levels, cost savings, environmental impact, and enhancement of quality etc. of the asphalt seal coat additive.

Current asphalt seal coat products require several different raw materials that are purchased and measured separately before being added to create the final product. The asphalt seal coat additive of the present invention replaces or supplements a percentage of ingredients for manufacturers, e.g., eight or more, eliminating the need to purchase and measure a percentage of these materials. This lowers material and operational costs, minimizes labor demands, and offers the opportunity to enhance the quality of the product with less environmental impact. The asphalt seal coat additive is unique from other asphalt seal products in that it utilizes post-consumer waste products including latex paint, amongst other waste products, in its formula, and as described in more detail herein. These post-consumer waste products can replace virgin raw materials, e.g., eight or more, traditionally found in asphalt seal coat formulas. Through the manufacturing and testing processes, it is possible to match desired percentages of various ingredients to create an optimum blend that will meet the quality demands of manufacturers.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The raw material substitute and manufacturing process for asphalt seal coat products may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 shows a comparison of conventional asphalt seal coat products and an asphalt seal coat product in accordance with aspects of the present invention.

FIG. 2 shows a flowchart of a manufacturing process of the asphalt seal coat product in accordance with aspects of the present invention.

### DETAILED DESCRIPTION

The present invention is directed to raw material substitute and manufacturing process for asphalt seal coat products. The origin of the asphalt seal coat additive (e.g., substitute) includes non-hazardous industrial waste streams. These waste streams comprise virgin architectural paint manufacturing waste (including, but not limited to, wash water, tank bottoms, skins, product recalls, mistints, non-conforming batches, and aged, surplus, off-spec raw materials); post-consumer latex paint products and biproducts from the paint recycling/manufacturing process (including, but not limited to wash water, skins, tank bottoms, solids, and non-conforming batches); and chemical manufacturing waste (including, but not limited to, toner powder ink cartridge manufacturing and/or recycling processes, resins, biocides, pigments, fillers, aggregates, and thickeners).

In embodiments, the customer determines the amount of each asphalt seal coat additive or substitute ingredient necessary for their manufacturing process. Next, based on the customer's specifications, various waste streams (described above) are sorted and manufactured as disclosed herein.

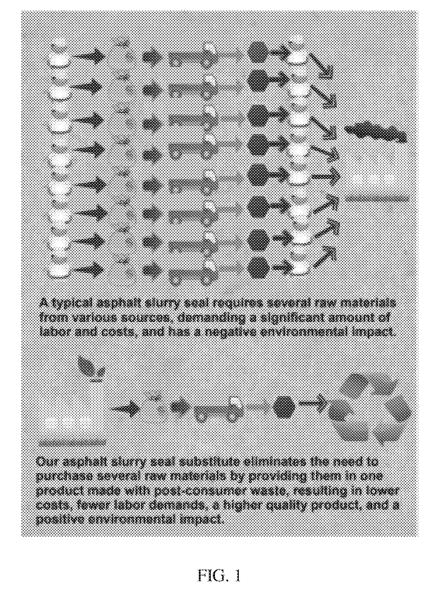

FIG. 1 shows a comparison of conventional asphalt seal coat products and an asphalt seal coat product in accordance with aspects of the present invention. Specifically, FIG. 1 generally depicts that a typical asphalt seal product requires raw materials from various sources, demanding a significant amount of labor and costs, with a negative impact of on the environment. In comparison, the asphalt seal coat product in accordance with aspects of the present invention eliminate the need to purchase raw materials by providing them in one mor product made with post-consumer waste, virgin architectural paint manufacturing waste, biproducts the paint recycling/manufacturing process and chemical manufacturing waste as described herein. This results in lower costs, few labor demands, a higher quality product and a positive environment impact.

For example, the asphalt seal coat product may be derived from post-consumer waste products, including latex paint, in its formula. In addition, the waste streams comprise virgin architectural paint manufacturing waste including, but not limited to, wash water, tank bottoms, skins, product recalls, mistints, non-conforming batches, and aged, surplus, off-spec raw materials; post-consumer latex paint products and biproducts from the paint recycling/manufacturing process including, but not limited to wash water, skins, tank bottoms, solids, and non-conforming batches); and chemical manufacturing waste including, but not limited to, toner powder ink cartridge manufacturing and/or recycling processes, resins, biocides, pigments, fillers, aggregates, and thickeners. These waste products can replace virgin raw materials, e.g., eight or more, traditionally found in asphalt seal coat formulas. Through the manufacturing and testing processes, it is possible to match desired percentages of various ingredients to create an optimum blend that will meet the quality demands of manufacturers.

More specifically, in embodiments, the asphalt seal coat additive that can be used with a customer’s product replaces virgin ingredients of traditional asphalt seal products with our post-consumer/manufacturer formula. The formula may contain a blend of the following ingredients from multiple non-hazardous industrial waste streams: 10-20% vinyl acrylic latex, 0-20% and preferably < 2% carbon black, < 5% fuller's earth, < 60% silica (amorphous), < 10% limestone, < 5% cellulose, < 20% quartz (SiO₂), and < 50% water. In further embodiments, the carbon black may be 1-15%, 5-25% or 10-35%, for example. Percentages of the ingredients may vary according to customer needs and specifications. The provided percentages are what was found to be the most common from laboratory and real world testing. The asphalt seal coat substitute formula may be customized according to the purchaser's raw materials requirements. For example, the formula may or may not contain aggregates, carbon black, acrylic resin, biocides, preservatives, PH adjustment, etc. These aspects of the formula can be customized based on the customer's demands. This may impact the viscosity, percent solids, weight per gallon, VOC levels, etc. of the asphalt seal coat substitute.

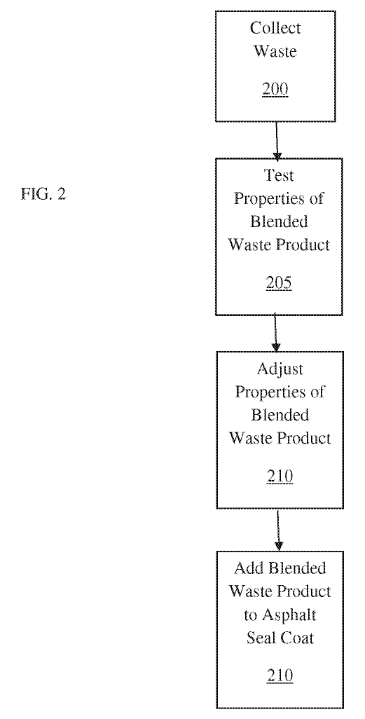

FIG. 2 shows a flowchart of a manufacturing process of the asphalt seal coat product in accordance with aspects of the present invention. At step 200, waste products are collected and blended together. At step 205, properties of the blended waste product may be checked. This includes, for example, Ph, viscosity, color and percent solids. The Ph can be tested using, for example, a digital pH meters for high accuracy (0.01 precision), pH test strips/litmus paper for quick color-coded approximations, and indicator solutions as is known in the art. Viscosity measurement determines a fluid's internal resistance to flow using devices like viscometers and rheometers. Key methods include rotational viscometers (measuring torque), viscosity cups (measuring gravity flow time), and falling ball methods as is known in the art. Color can be determined by using a spectrophotometer as is known in the art. Testing percent solids may be performed by measuring a sample's weight before and after drying using gravimetric methods as is known in the art.

At step 210, any adjustments to the blend, e.g., formula, may be made based on the testing. For example, Ph may be balanced by pH adjusters such as ammonia. For example, to raise pH, it is possible to use acids like phosphoric acid, citric acid, or vinegar and to lower pH, it is possible to use bases like soda ash or baking soda. It is also possible to adjust color by adding carbon black, e.g., to increase the black or gray tone. To increase solid percentage, it is possible to use titanium oxide, silica or fuller’s earth as examples. It is also possible to add resins. At step 215, a filtration process may be performed and the seal coat product can be packaged and added to existing seal coats.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and

are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

1. A seal coat additive comprising waste products in a blend comprising water and materials selected from the group consisting of vinyl acrylic latex, carbon black, fuller's earth, silica limestone, cellulose and quartz.

2. The seal coat additive of claim 1, wherein the vinyl acrylic latex is 10-20% of the blend.

3. The seal coat additive of claim 1, wherein the carbon black is 0-20% of the blend.

4. The seal coat additive of claim 1, wherein the carbon black is less than 2% of the blend.

5. The seal coat additive of claim 1, wherein the fuller’s earth is less than 5% of the blend.

6. The seal coat additive of claim 1, wherein the silica is amorphous.

7. The seal coat additive of claim 6, wherein the silica is less than 60% of the blend.

8. The seal coat additive of claim 1, wherein the limestone is less than 10% of the blend.

9. The seal coat additive of claim 1, wherein the cellulose is less than 5% of the blend.

10. The seal coat additive of claim 1, wherein the quartz is less than 20% of the blend.

11. The seal coat additive of claim 1, wherein the water is less than 50% of the blend.

12. The seal coat additive of claim 1, wherein the waste products comprise post-consumer waste products.

13. The seal coat additive of claim 12, wherein the post-consumer waste products comprise latex paint.

14. The seal coat additive of claim 12, wherein the post-consumer waste products comprise at least one of wash water, tank bottoms, skins, product recalls, mistints, non-conforming batches, aged, surplus, or off-spec raw materials.

15. The seal coat additive of claim 1, wherein the waste products comprise virgin architectural paint manufacturing waste.

16. The seal coat additive of claim 15, wherein the virgin architectural paint manufacturing waste comprises at least one of wash water, tank bottoms, skins, product recalls, mistints, non-conforming batches, aged, surplus, or off-spec raw materials.

17. The seal coat additive of claim 1, wherein the waste products comprise chemical manufacturing waste.

18. The seal coat additive of claim 17, wherein the chemical manufacturing waste comprises at least one of toner powder ink cartridge manufacturing and/or recycling processes, resins, biocides, pigments, fillers, aggregates, or thickeners.

19. A seal coat additive comprising waste products blended together, the blend comprising vinyl acrylic latex, carbon black, fuller's earth, silica limestone, cellulose, quartz and water.

20. The seal coat additive of claim 19, wherein:
the vinyl acrylic latex is 10-20% of the blend;
the carbon black is less than 2% of the blend;
the fuller’s earth is less than 5% of the blend;
the silica is less than 60% of the blend;
the limestone is less than 10% of the blend;
the cellulose is less than 5% of the blend;
the quartz is less than 20% of the blend and
the water is less than 50% of the blend.
